(19) United States
(12) Patent Application Publication
(10) Pub. No.: US 2003/0230258 A1
(43) Pub. Date: Dec. 18, 2003

(54) Two-stroke engines exhaust and scavenge control

(76) Inventor: Hector Alvaro Javier Niemiz, Parana (AR)

Correspondence Address: Hector Alvaro Javier Niemiz, Ayacucho 1631, Parana, 3100, AR

(21) Appl. No.: 10/170,114

(22) Filed: Jun. 12, 2002

(51) Int. Cl. F02B 75/02

(52) U.S. Cl. 123/65 V

(57) ABSTRACT

A system of controlling the exhaust and scavenge process for two-stroke piston engines with crankcase scavenge and fed by air/fuel mixture, which has a rotary valve adjacent to the cylinder exhaust port/s that rotates in synchronism with the crankshaft enabling the control of the exhaust gases initial speed and preventing the air/fuel mixture from leaking to the exhaust system during the compression stroke; this way, the engine power is improved, and the CO and HC emissions and oil and fuel consumption are reduced.

### FIELD OF THE INVENTION

It applies to two-stroke piston engines, spark ignited, carbureted or fuel-injected, with crankcase scavenge and exhaust port/s.

### BACKGROUND

In order to understand the problem that is solved with this invention, the functioning of carbureted spark ignited two-stroke engines with crankcase scavenge will be explained.

First, we will analyze its functioning with load and at different number of revolutions.

During the expansion stroke, when the piston uncovers the exhaust port gases go out through it due to the difference in the pressure between the cylinder and the exhaust system. Then, when the piston uncovers the intake port, the air/fuel mixture gets into the cylinder in a process called scavenge. When the piston begins the upstroke and covers the intake port, the scavenging finishes and the exhaust port remains uncovered, at this moment the whole exhaust system (manifold, pipe and silencer) plays an important role since it has been designed to be able to cause—when reaching a certain number of revolutions (rpm) and according to its shape and volume—such a stationary pressure wave that can oppose to the leakage of air/fuel mixture out of the exhaust port.

The exhaust system—due to its shape and volume—is optimum at a certain load and engine revolutions, but when different, it becomes unable to prevent part of the air/fuel mixture from passing through the exhaust port reaching the exhaust system. This causes high emissions of unburned hydrocarbons and high fuel consumption at the same time.

With small throttle openings, the combustion would not be stable due to misfiring, because the reduced scavenge volume makes it difficult to concentrate in the proximity of the spark plug such an air/fuel relationship that would enable the ignition. Because of this, combustion does not occur or it is only partially produced, causing that a great amount of unburned hydrocarbons and carbon monoxide leak out to the atmosphere.

### BRIEF DESCRIPTION OF THE INVENTION

This invention is a system of controlling the exhaust and scavenge process for two-stroke piston engines with crankcase scavenge and fed by air/fuel mixture, which has a rotary valve adjacent to the cylinder exhaust port/s that rotates in synchronism with the crankshaft enabling the control of the exhaust gases initial speed and preventing the air/fuel mixture from leaking to the exhaust system during the compression stroke; this way, the engine power is improved, and the CO and HC emissions and oil and fuel consumption are reduced.

### BRIEF DESCRIPTION OF THE DRAWINGS

FIGS. 1, 2, 3 and 5 are cross-sections of a single cylinder two-stroke engine with crankcase scavenge and spark ignited. Only the constitutive parts necessary for the right compression of the new system for controlling the exhaust and scavenge process have been included in these figures.

FIG. 1 shows the position of the piston (1) and the rotary valve (2) at the moment of the exhaust opening advance (EOA).

FIG. 2 represents the engine top dead center where the position of the piston (1) and the rotary valve (2) could be seen.

FIG. 3 shows the position of the piston (1) and the rotary valve (2) at the intake closure delay (ICD).

FIG. 4 represents a circular distribution diagram where the intake and exhaust opening and closure angles are shown.

FIG. 5 describes the case in which the rotary valve (2) covers the exhaust port (3) before the piston (1) covers the intake ports (4).

### DETAILED DESCRIPTION OF THE INVENTION

In order to explain the functioning of the system of controlling the exhaust and scavenge process, as an example we will use a conventional single-cylinder two-stroke engine with crankcase scavenge, carbureted, which has a rotary valve (2) adjacent to the exhaust port (4) of the cylinder (6) and is commanded by the crankshaft in a 1 to 1 transmission ratio. The command mechanism is not represented in the figures. The crankshaft and the rotary valve (2) rotate clockwise.

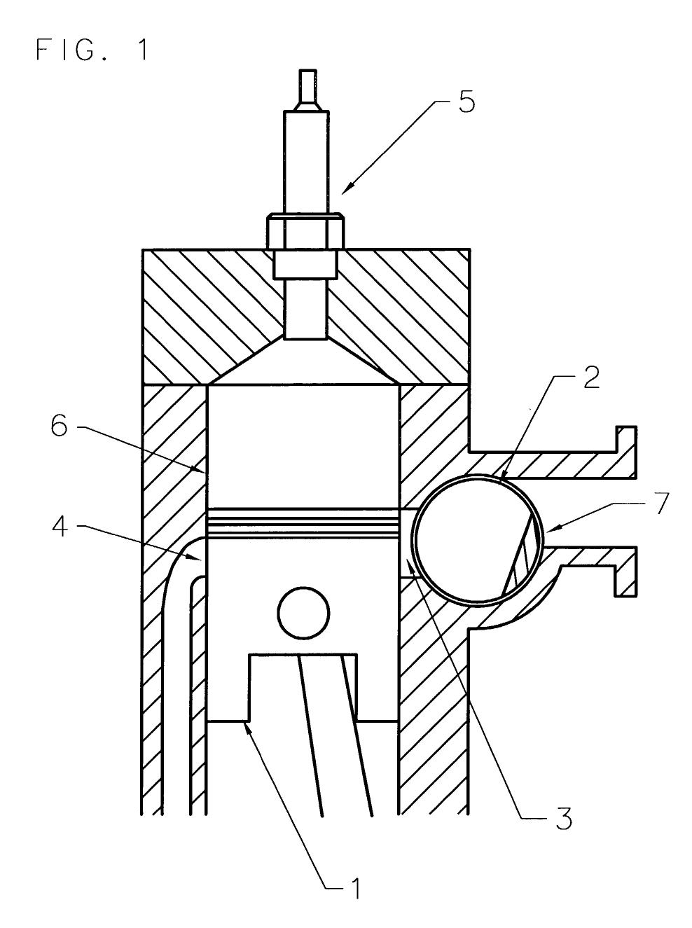

FIG. 1 represents the power stroke at the moment of the exhaust opening advance (EOA), that is, from that moment on the exhaust gases will begin going out from the cylinder (6) through the exhaust port (3) and from the rotary valve (2) to the exhaust system. It can be seen in this figure that the rotary valve (2) partially blocks the exhaust gases exit since it restricts the passage section (7) to the exhaust system.

This way, the initial speed of the exhaust gases exit is controlled.

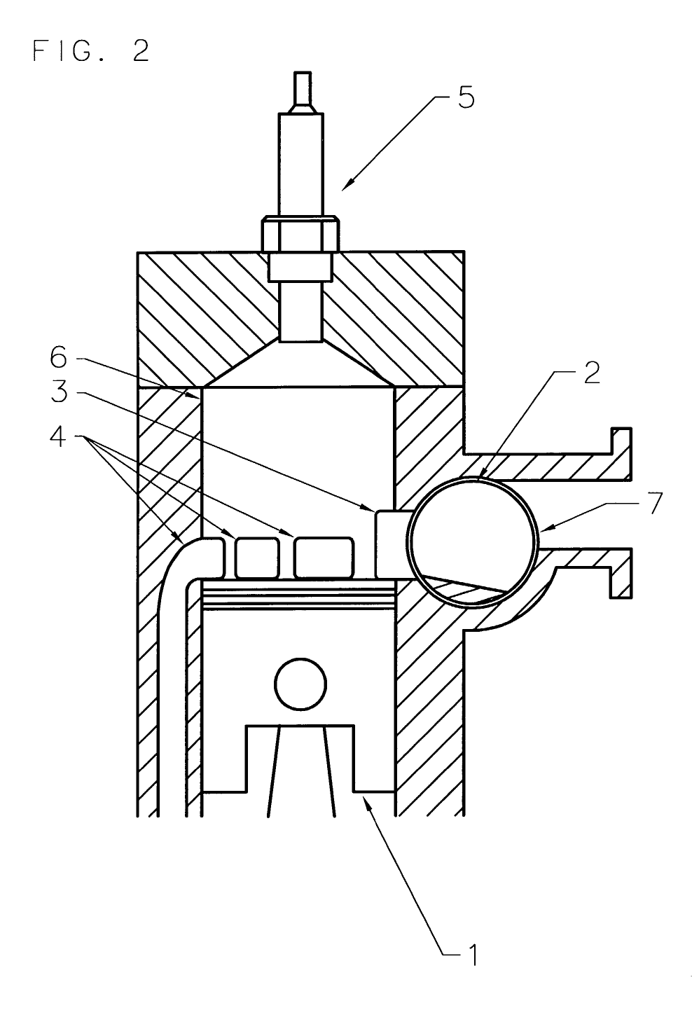

FIG. 2 shows the bottom dead center (BDC) in which it can be seen that the exhaust port (3) has been completely uncovered by the piston (1) and also that the rotary valve (2) does not interfere with the exhaust port (3) passage section nor with the passage section (7) to the exhaust system; therefore, the exhaust gases keep going out from the cylinder (6) through the exhaust port (3) and from the rotary valve (2) towards the exhaust system. At the same time, and since the piston (1) compresses the crankcase mixture and it has also uncovered the intake ports (4), the air/fuel mixture coming form the crankcase gets into the cylinder (6) through them.

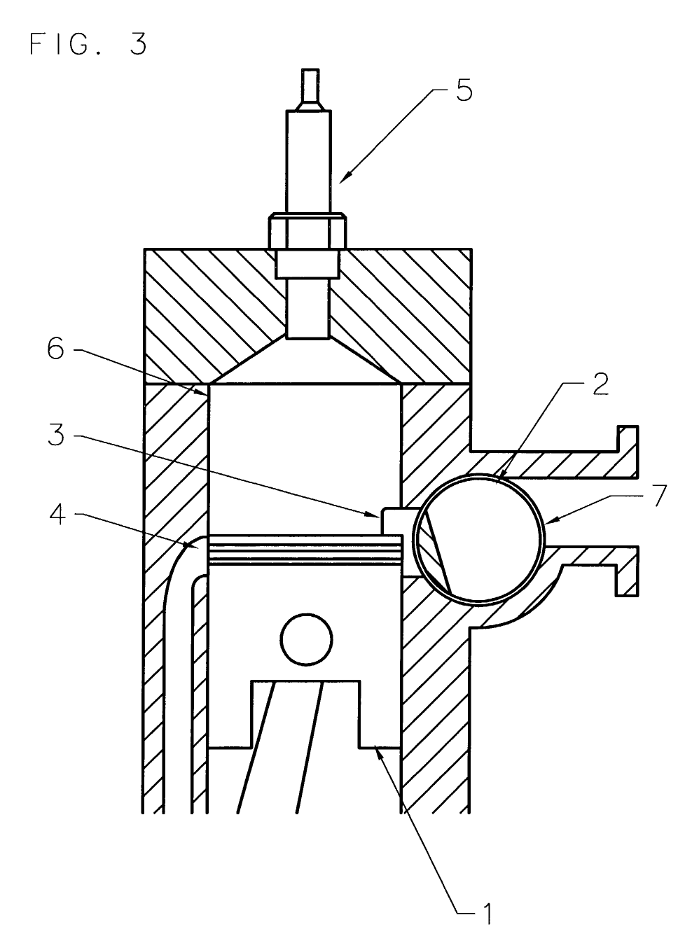

FIG. 3 represents the intake closure delay (ICD). As it can be noted, the intake ports (4) have been covered by the piston (1), thus ending the mixture entrance to the cylinder (6), it also shows that the exhaust port (3) is covered by the rotary valve (2) preventing the mixture leakage to the exhaust system, which remains in the cylinder (6). Besides, the effective expansion stroke of the engine is increased, as it can also be seen in the figure.

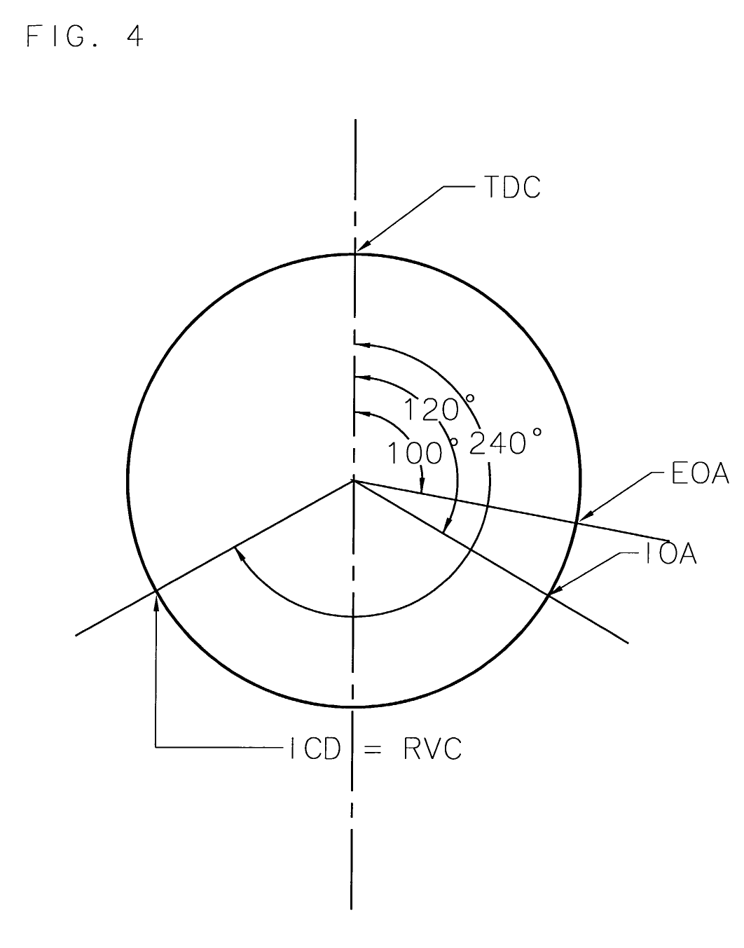

FIG. 4 is a distribution diagram in which both the intake and exhaust opening and closure angles are shown, measured from the top dead center (TDC) for the example explained in FIGS. 1, 2 and 3.

It represents the top dead center (TDC); in clockwise direction (like the engine rotation) the exhaust opening advance (EOA) is showed first (represented in FIG. 1), then the intake opening advance (10A), after that the bottom dead center (BDC) (represented in FIG. 2) and finally the point where the rotary valve covers the exhaust port (RVC) coinciding with the intake closure delay (ICD). The last point is represented in FIG. 3.

The rotary valve closure (RVC) can coincide with the intake closure delay (ICD) or not, this can be selected as convenient by advancing or delaying it.

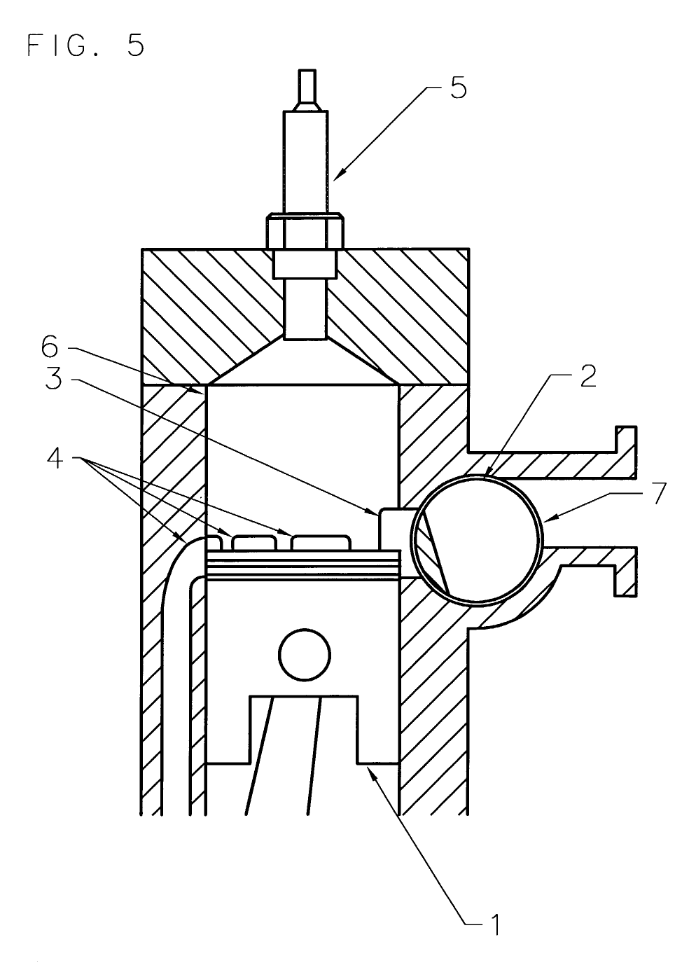

FIG. 5 shows the case in which the rotary valve (2) closes the exhaust port (3) before the piston (1) covers the intake ports (4) in its compression stroke. This valve tuning enables the control of the scavenge process, limiting it even more than in the case shown in FIG. 3. As it can be noted from the previous explanations, the rotary valve (2) has two functions: the first one is to control the exhaust process limiting the initial speed of the exhaust gases when they begin flowing out. The second one is to control the scavenge process to avoid the leakage of the air/fuel mixture from the cylinder (6) to the exhaust system in the compression cycle.

By limiting the exhaust gases speed when they begin flowing out, the available heat and temperature are increased, at the moment when the scavenge process begins, which occurs when the piston (1) begins to uncover the intake ports (4), during this process part of the mixture fuel is decomposed due to the heat from the exhaust gases, thus producing chemically activated radicals.

These radicals are highly combustible and therefore, the load containing them will be easily ignited and burned. By controlling the exhaust port closure (4) independently from the piston (1) movement, the rotary valve (2) allows to regulate the scavenge process duration, preventing the mixture from being driven out to the exhaust system, holding the air/fuel mixture thermally activated in the cylinder (6) and increasing the effective compression stroke.

Once the piston (1) compresses the mixture, the combustion is started by the spark produced by the spark plug (5), which easily ignites and burns the mixture due to the activated radicals. Likewise, if the mixture reaches the necessary temperature and pressure, it is ignited by such radicals.

With this controlling process, a stable combustion is achieved with light engine load and the levels of carbon monoxide emissions are reduced to almost zero.

With heavy engine loads, the unburned hydrocarbon emissions can be controlled considerably reducing the oil and fuel consumption and improving the engine torque. In order to get a better understanding of the system of controlling the exhaust and scavenge process functioning, a CD with four animations has been attached to this (appendix 3).

Animation 1 is a view from the inside of the cylinder showing the piston and rotary valve movement.

Animation 2 is a view in perspective of the cylinder with the rotary valve.

Animation 3 is a cross section clearly showing how the rotary valve carries out the two functions described above: to limit the exhaust gases exiting speed and hold the mixture inside the cylinder during the compression stroke.

Animation 4 is a cross section showing the engine functioning form a different point of view.

The system of controlling the exhaust and scavenge process is very easy to put into practice, since any conventional two-stroke engine can be used. Because of this, it was chosen a spark-ignited, carbureted scooter engine of 75 cc, lubricated by an oil pump with injection to the intake manifold, crankcase scavenge and air cooling system, to which a rotary valve was adapted adjacent to the cylinder exhaust port, controlled by the crankshaft with a 1 to 1 transmission ratio, using a timing belt and a pair of gearings to that end. In this case, the rotary valve was mounted on auto-lubricated bearings since this kind of engines does not have forced lubrication circuits.

The rotary valve was designed in such a way that it closes the exhaust port at the same time that the piston covers the intake ports during the compression stroke, as it is shown in FIG. 3 and in FIG. 4 distribution diagram. Animations 1, 2, 3 and 4 in the attached CD (appendix a3), have been developed following all the sizes of this engine and of the rotary valve adapted to it.

The compression ratio had to be reduced from the standard 10.4 to 1 to 8 to 1, because excessive auto-ignition of the mixture was produced under certain conditions of engine load.

The described engine was used to carry out measurements of fuel consumption, gases emissions and engine torque. Such tests were carried out by the staff from Parana and Concepcion del Uruguay Districts belonging to the National Technological University (“Universidad Tecnologica Nacional”), both from the Argentine Republic. The attached evaluative technical report (appendix al) and the report on the exhaust fumes measurements (appendix a2) are precise descriptions of how the mentioned tests were carried out and which were the results.

It was noted in the testing that when the engine load is not much, with the throttle between 15 and 30 percent and between 4,000 rpm and 8,500 rpm, the engine functions with auto-ignition, but outside this range the mixture ignition is started by the spark plug.

It was also observed that the engine could work stood idle with stable combustion, the CO emissions are just 0.26% in volume compared to the 3.4% of the standard engine and the HC emissions are 3055 parts per million against 5955 parts per million of the standard engine. The air/fuel relationship that can be used standing idle is very low (lambda 1.53). At higher number of revolutions (5900 rpm) and light load, the CO emission levels are reduced to 0.11% in volume and the HC emissions are also reduced, to 1321 parts per million.

The fuel consumption tests show that the better reduction of consumption is produced at high number of revolutions and heavy engine load, reaching up to 45% (appendix al, charts 1 and 3 in the evaluative technical report). This means that the emission of unburned hydrocarbons can be effectively controlled with heavy load and high number of revolutions of the engine. Lower air/gasoline ratios could also be used (lambda 1.2) due to the presence of activated radicals in the combustion chamber, which even though they are not enough to automatically ignite the mixture, they make it easier to ignite and burn.

As regards the oil consumption, the best reduction is also obtained with heavy load and high number of revolutions, reaching 46% (appendix al, charts 5 and 7 in the evaluative technical report).

The engine torque is also increased as shown in charts 11 and 12 of the evaluative technical report (appendix a1).

These tests show that with the system of controlling the exhaust and scavenge process, as explained above, fuel consumption and CO and HC emissions are considerable reduced, and the engine torque, increased.

The rotary valve (2), as well as its housing and layout, can have different shapes according to the design and to each particular application, as well as to the control mechanism.

The rotary valve (2) can be mounted on bearings or bushings, and the cooling system may use air, water or oil, as deemed convenient.

The rotary valve (2) can also be equipped with any mechanism of angular variation, that is, it can close the exhaust port (3) standing idle in a certain position and, as the engine revolutions change, it can modify its angular position in relation to the crankshaft, thus delaying or anticipating the exhaust port (3) closure moment. This would enable the control of the exhaust and scavenge process as desired, according to the load and engine revolutions or acceleration.

The system of controlling the exhaust and scavenge process can be applied to engines with different types of scavenge and fuel feeding, whether injected or carbureted, and also to those using alcohol or kerosene as fuel.

What I claim as my invention is:

1. A new system of controlling the exhaust and scavenge process for two-stroke piston engines with crankcase scavenge, of the kind in which the air/fuel mixture is driven into the cylinder during the scavenge stroke, which is characterized by having a rotary valve adjacent to the cylinder exhaust port that rotates in synchronism with the crankshaft

2. A system of controlling the exhaust and scavenge process as in claim 1, characterized by the feature that the rotary valve adjacent to the cylinder exhaust port/s controls the initial speed of exhaust gases when such process begins.

3. A system of controlling the exhaust and scavenge process as in claim 1, characterized by the feature that the rotary valve adjacent to the cylinder exhaust port/s closes such port/s controlling the scavenge process during the engine compression stroke.
